(19) United States
(12) Patent Application Publication
(10) Pub. No.: US 2009/0319428 A1
(43) Pub. Date: Dec. 24, 2009

(54) Authorizing An Electronic Payment Request

(75) Inventors: Barbara Febonio, Rome (IT); Sandro Piccinini, Rome (IT)

Correspondence Address: IBM CORPORATION;INTELLECTUAL PROPERTY LAW, 11501 BURNET ROAD, AUSTIN, TX, 78758, US

(73) Assignee: International Business Machines Corporation, Armonk, NY (US)

(21) Appl. No.: 12/486,073

(22) Filed: Jun. 17, 2009

(30) Foreign Application Priority Data
Jun. 24, 2008 (EP) 08158820.4

(51) Int. Cl. G06Q 20/00

(52) U.S. Cl. 705/44

(57) ABSTRACT

An electronic payment request is authorized using a plurality of electronic codes. A first code is requested from a user on receipt of a payment request made with a payment card configured with one or more details of one or more devices in the possession of one or more owners of the card. The payment is refused in the event the first code does not substantially match a predefined second code. A third code is requested from the one or more devices with whose details the payment card is configured if the first code substantially matches the second code. The third code is compared with a predefined fourth code. The payment is refused in the event the third code does not substantially match the fourth code, while the payment is authorized in the event the third code substantially matches the fourth code.

### TECHNICAL FIELD

The present invention relates to a method, system and computer program for authorizing an electronic payment request

### BACKGROUND

In an increasingly digital world, people today rarely use cash for making payments. Instead, they tend to use bank cards, credit cards, debit cards or cash cards for making payments. These payment systems are relatively secure because they employ extensive security mechanisms. In particular, in most of these payment systems, a secret code must be provided by a purchaser and authenticated by a bank, to authorise the movement of funds from the purchaser's account to the vendor.

Recent years have seen rapid growth in the use of credit cards and/or debit cards to purchase merchandise at point-of-sale locations, through public telephones or over the Internet. During these purchase transactions some personal data is publicly released, albeit in a very limited way. However, in view of the inherently public nature of telephone networks and/or the Internet, this personal information is at risk of interception.

Identity theft is recognised as an increasingly important crime, wherein, despite all of the security checks used to authenticate and protect personal information, a credit/debit card may be cloned and used by malicious persons to rob money from the bank account of a legitimate user. In fact, in view of the almost instantaneous nature of today's electronic transactions, even temporary ownership of a credit (or other payment) card could allow a malicious user to make a large number of payments either on the Internet or by physically accessing places which accept such cards.

US patent application No. US2006/0131390 describes a system for providing a notification of a pending transaction request and obtaining an authorization from a cardholder. The system includes a phone number of a mobile device assigned to receive an authorization request for a respective account. When a transaction request is received, the system identifies the phone number of the mobile device assigned to receive authorization request messages for the account requesting the transaction. The system generates and transmits an authorization request message to the determined phone number; and a reply message is returned from the mobile device which explicitly indicates if the user of the mobile device approves or refuses this transaction.

In a similar vein, US patent application No US2004/0177040 describes a method for securing a card transaction using a mobile device which is capable of preventing the card from being embezzled and counterfeited.

Both US2006/0131390 and US2004/0177040 effectively use a mobile device to send an authorization request and await a reply message to authorise a payment request. Thus, these systems require:
an available mobile phone network to process the payment request;
a payment area which has a valid network signal (which is not always available in multi level stores); and
an interaction with the user who must reply to the authorization request.

### SUMMARY OF THE INVENTION

According to the invention, there is provided a method, system and computer product for authorizing an electronic payment request. A first code is requested from a user on receipt of a payment request made with a payment card configured with one or more details of one or more devices in the possession of one or more owners of the card. The payment is refused in the event the first code does not substantially match a predefined second code. A third code is requested from the one or more devices with whose details the payment card is configured if the first code substantially matches the second code. The third code is compared with a predefined fourth code. The payment is refused in the event the third code does not substantially match the fourth code, while the payment is authorized in the event the third code substantially matches the fourth code.

### BRIEF DESCRIPTION OF THE DRAWINGS

An embodiment of the invention is herein described, by way of example, only with reference to the accompanying figures in which:

FIG. 1 is a block diagram of a system of the preferred embodiment;

FIG. 2 is a flow chart of the method of the preferred embodiment; and

FIG. 3 is a block diagram of a computer system adapted to perform the method of preferred embodiment.

### DETAILED DESCRIPTION

For simplicity, credit, debit, bank and cash cards etc. will be generically known henceforth as “payment cards”. One of the main problems with traditional mechanisms for authenticating a payment card is that these mechanisms all employ codes (or keys) that reside on the payment card itself. Thus, a malicious and technical expert could easily clone a payment card or otherwise attack a user's account to gain access.

The preferred embodiment ensures that the authentication of a debit/credit card is not solely reliant upon the card itself. Instead, the preferred embodiment provides an additional layer of security into an authentication process, wherein this additional layer of security is executed through an external device owned by the purchaser, before an electronic payment is authorized.

The preferred embodiment minimally interferes with the existing security structures of banks and/or vendors. In particular, the preferred embodiment does not alter traditional authentication mechanisms. Instead, the new functionality of the preferred embodiment can be simply plugged into an existing traditional security mechanism and sold as a new service by a bank.

The preferred embodiment can also leverage a user's personal information (and user's external device) to advise a user of an authentication failure, thereby providing almost instantaneous warning to the user of a potential breach in their security.

In contrast, with the aforementioned prior art documents, the preferred embodiment can leverage the following technologies:

(a) RFID technology to read an authorization profile from a user-owned tag;

(b) a bluetooth connection that is capable of:
silently reading if the user is carrying a device whose unique identifier (e.g. cellular IMEI) matches the one specified in the profile on the card;
establishing a bluetooth handshake requiring a pin;
physically verifying that the user making the payment is in BT range.

(c) Infra-red communication, or more particularly, an infrared data association (IrDA) connection to read the authorization code from a user-owned device/tag.

Moreover, the preferred embodiment can leverage any type of profile stored in a user's mobile device to perform a check on a payment transaction. In particular, the preferred embodiment can automatically check a specific payment against a defined user-profile (e.g., an expenditure threshold for a particular type of shopping or a daily expenditure threshold, etc.).

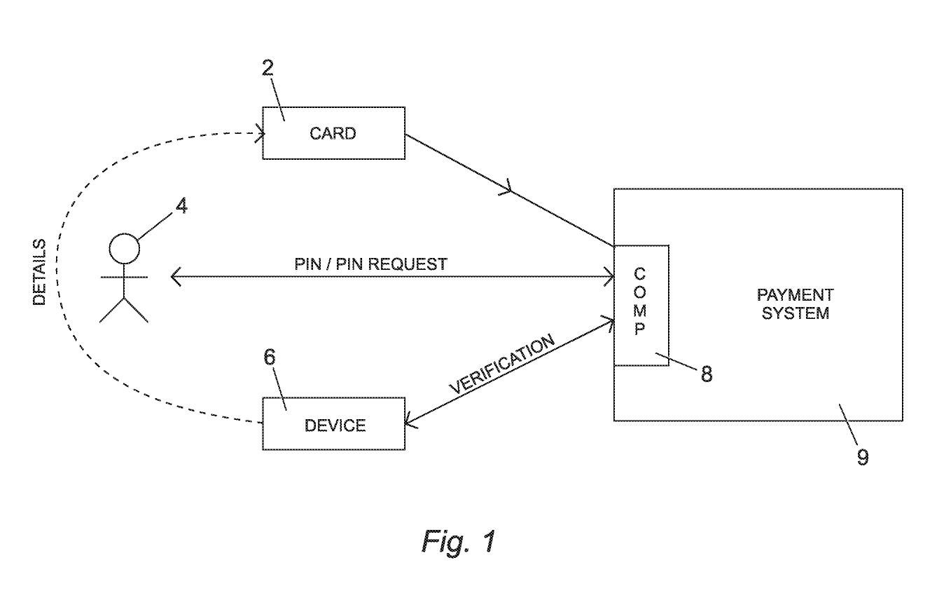

Referring to FIG. 1, the preferred embodiment provides a mechanism for solving the problem of identity theft by introducing a dual-layer authentication system for accessing the funds and/or credit through payment cards 2. More particularly, the preferred embodiment provides an additional check regarding the identity of a card user 4 to be included within a traditional security protocols for these cards 2, wherein the additional check is based on an authentication channel which is external to the user's card 2. To this end, the preferred embodiment leverages the use of a device 6 (owned by the legitimate card owner) to certify that the user of the card 2 at any given instant is the legitimate owner of the card 2 and not someone else.

In support of the above, one preferred embodiment includes additional information into a traditional payment card. The additional information includes features that can be used to verify the identity of the registered owner of the card. For example, the additional information could include: a number of the registered owners mobile phone; a unique International Mobile Equipment Identity (IMEI) code of the registered owner's mobile phone; and an identifier of an RFID tag carried by the registered owner.

To process this additional information, the preferred embodiment includes a pluggable component, which in use is installed into a payment system. The pluggable component is adapted to check the identity of the user of a payment card based on the additional information embedded within the card.

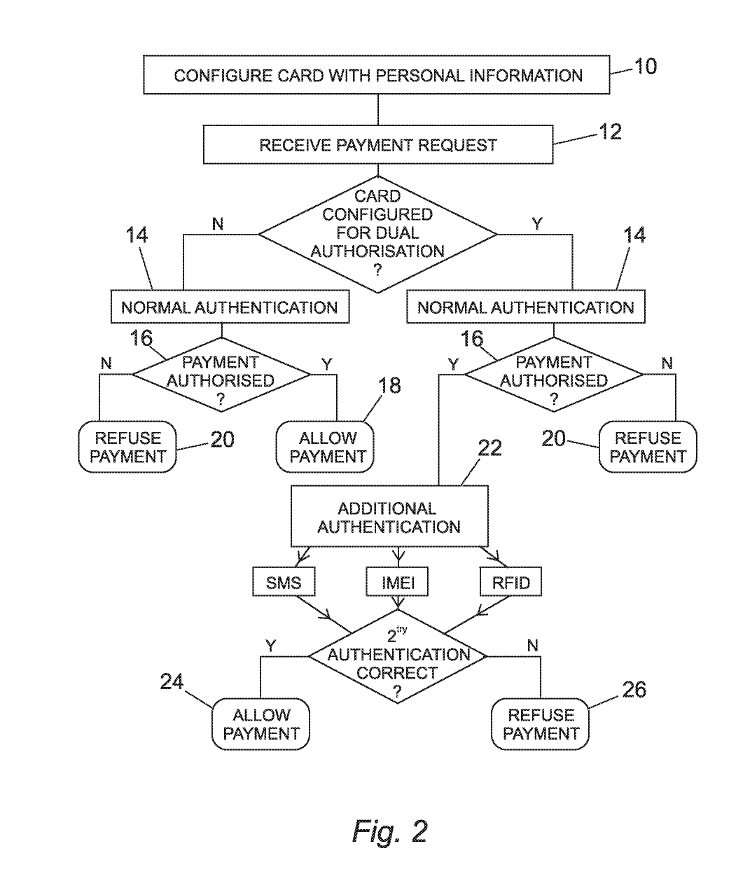

Referring to FIG. 2, in an initialization step, a bank (and/or another credit or funds provider) allows a user to opt into the dual-layer authentication system of the preferred embodiment. Should the user opt to avail of the dual-layer authentication system, the preferred embodiment allows 10 the user to configure their payment card with selected information pertaining to one or more of the their personal devices.

On receiving 12 a payment request, made with the user's payment card, the preferred embodiment verifies that the payment card is configured for the dual-layer authentication process. In the event the payment card is not configured for dual-layer authentication, the preferred embodiment performs the traditional steps of authenticating 14 the card in a payment request and authorizing 18 the payment in the event the card is authenticated 16 and otherwise refusing 20 the payment.

In the event the user's payment card is configured for dual-layer authentication, the preferred embodiment performs most of the traditional authentication 14 steps mentioned above (including refusing 20 payment in the event the card is not authenticated). However, in contrast with the traditional authentication process, which would simply make the payment if the card is authorized 18, the preferred embodiment automatically (or on reaching a preconfigured threshold) performs an additional authentication 22 step, which could comprise inter alia, the following operations:
making a specific call or sending a specific SMS message to the phone number specified in the payment card used for making the payment request and waiting for a preconfigured answer to the call (wherein the answer may take the form of a predefined SMS message, vocal password etc.); or
attempting to establish a bluetooth handshake with the phone identified in the card used to make the payment request (assuming that the phone is in range of a bluetooth transmitter) and checking the IMEI code retrieved from the phone against the IMEI code detailed in the payment card; or
attempting to read the secret information or password stored in the RFID tag identified in the card used for making the payment request.

In the event, the secondary authentication step is successful, the preferred embodiment allows the payment to be made. Otherwise, the preferred embodiment refuses the payment request. The preferred embodiment may also issue a warning message to the phone identified within the card, in the event of a failed attempt to make a payment using the card. An alternate embodiment performs the steps in the reverse order, so that the local check is performed first (i.e. so that no external connection is required).

While the above discussion has described the additional authentication step as following the traditional normal authentication step, nonetheless, it will be understood that the preferred embodiment is not limited to this particular implementation, in particular, the preferred embodiment may perform the additional authentication step before the traditional authentication steps.

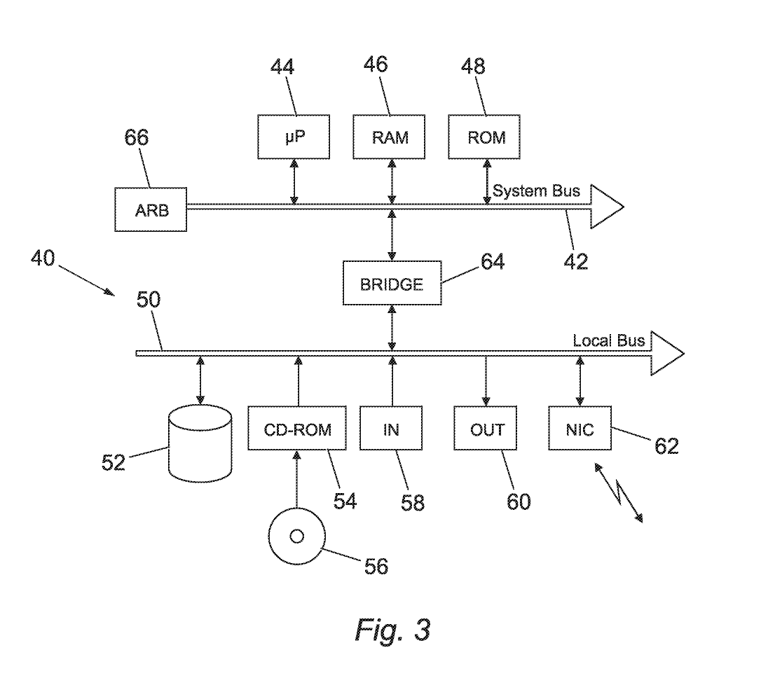

Referring to FIG. 3, a generic computer system 40 is adapted to support the preferred embodiments is formed by several units that are connected in parallel to a system bus 42. In detail, one or more microprocessors (XP) 44 control operation of the computer 40; a RAM 48 is directly used as a working memory by the microprocessors 44, and a ROM 48 stores basic code for a bootstrap of the computer 40. Peripheral units are clustered around a local bus 50 (by means of respective interfaces). Particularly, a mass memory consists of a hard-disk 52 and a drive 54 for reading CD-ROMs 56. Moreover, the computer 40 includes input devices 58 (for example, a keyboard and a mouse), and output devices 60 (for example, a monitor and a printer). A Network Interface Card (NIG) 62 is used to connect the computer 40 to the network. A bridge unit 64 interfaces the system bus 42 with the local bus 50. Each microprocessor 44 and the bridge unit 84 can operate as master agents requesting an access to the system bus 42 for transmitting information. An arbiter 86 manages the granting of the access with mutual exclusion to the system bus 42.

Similar considerations apply if the system has a different topology, or it is based on other networks. Alternatively, the computers have a different structure, including equivalent units, or consist of other data processing entities (such as PDAs, mobile phones and the like).

Alterations and modifications may be made to the above without departing from the scope of the invention.

1. A method for authorizing an electronic payment request, the method comprising:
requesting a first code from a user on receipt of a payment request made with a payment card configured with a one or more details of a one or more devices in the possession of a one or more owners of the card;
refusing to make the payment in the event the first code does not substantially match a predefined second code;
requesting a third code from the one or more devices with whose details the payment card is configured, in the event the first code substantially matches the second code;
comparing the third code with a predefined fourth code;
refusing to make the payment in the event the third code does not substantially match the fourth code: and
authorizing the payment in the event the third code substantially matches the fourth code.

2. The method as claimed in claim 1, wherein the method further comprises configuring the payment card with a phone number of a mobile phone of the owner of the card; and requesting a third code comprises making a call to the mobile phone and waiting for a preconfigured answer to the call.

3. The method as claimed in claim 2 wherein comparing the third code with a predefined fourth code comprises comparing the third code with a predefined vocal password.

4. The method as claimed in claim 2, wherein requesting a third code comprises sending an SMS message to the mobile phone and waiting for a preconfigured answer to the SMS message.

5. The method as claimed in claim 4 wherein comparing the third code with a predefined fourth code comprises comparing the third code with a predefined SMS message.

6. The method as claimed in claim 1 wherein the method further comprises configuring the payment card with an International Mobile Equipment Identity (IMEI) code of a mobile phone of the owner of the card and wherein requesting a third code comprises attempting to establish a bluetooth connection with the mobile phone; and wherein
comparing the third code with a predefined fourth code comprises comparing an International Mobile Equipment Identity (IMEI) code retrieved from the mobile phone with the IMEI with which the payment card is configured.

7. The method as claimed in claim 1 wherein the method further comprises configuring the payment card with an identifier of a radio frequency identification tag on the person of an owner of the card; and wherein
requesting a third code comprises attempting to read a code from the radio frequency identification tag.

8. The method as claimed in claim 1 wherein requesting a third code from the device with whose details the payment card is configured is not conditional upon the matching of the first code with the second code; and wherein:
requesting a third code from the device
comparing the third code with a predefined fourth code; and
refusing to make the payment in the event the third code does not substantially match the fourth code, precede:
requesting a first code from a second user on receipt of a payment request made with the payment card; and
refusing to make the payment in the event the first code does not substantially match a predefined second code.

9. The method as claimed in claim 1 wherein the method comprising an initial step of allowing a user to choose whether to avail of the method; and failing to execute the steps of:
requesting a third code from the device with whose details the payment card is configured;
comparing the third code with a predefined fourth code; and
refusing to make the payment in the event the third code does not substantially match the fourth code; in the event the user has chosen not to avail of the method.

10. A system for for authorizing an electronic payment request, the system comprising:
a processor;
a memory for storing instructions which when executed by the processor cause the system to execute the method comprising;
requesting a first code from a user on receipt of a payment request made with a payment card configured with a one or more details of a one or more devices in the possession of a one or more owners of the card;
refusing to make the payment in the event the first code does not substantially match a predefined second code;
requesting a third code from the one or more devices with whose details the payment card is configured, in the event the first code substantially matches the second code;
comparing the third code with a predefined fourth code;
refusing to make the payment in the event the third code does not substantially match the fourth code; and
authorizing the payment in the event the third code substantially matches the fourth code.

11. A computer program product stored in a medium readable by a computer machine, the computer program product tangibly embodying readable program means by causing the computer to perform the method comprising:
requesting a first code from a user on receipt of a payment request made with a payment card configured with a one or more details of a one or more devices in the possession of a one or more owners of the card;
refusing to make the payment in the event the first code does not substantially match a predefined second code;
requesting a third code from the one or more devices with whose details the payment card is configured, in the event the first code substantially matches the second code;
comparing the third code with a predefined fourth code;
refusing to make the payment in the event the third code does not substantially match the fourth code; and
authorizing the payment in the event the third code substantially matches the fourth code.

12. The product as claimed in claim 11, wherein the method further comprises configuring the payment card with a phone number of a mobile phone of the owner of the card; and requesting a third code comprises making a call to the mobile phone and waiting for a preconfigured answer to the call.

13. The product as claimed in claim 12 wherein comparing the third code with a predefined fourth code comprises comparing the third code with a predefined vocal password.

14. The product as claimed in claim 12, wherein requesting a third code comprises sending an SMS message to the mobile phone and waiting for a preconfigured answer to the SMS message.

15. The product as claimed in claim 14 wherein comparing the third code with a predefined fourth code comprises comparing the third code with a predefined SMS message.

16. The product as claimed in claim 11 wherein the method further comprises configuring the payment card with an International Mobile Equipment Identity (IMEI) code of a mobile phone of the owner of the card and wherein requesting a third code comprises attempting to establish a bluetooth connection with the mobile phone; and wherein comparing the third code with a predefined fourth code comprises comparing an International Mobile Equipment Identity (IMEI) code retrieved from the mobile phone with the IMEI with which the payment card is configured.

17. The product as claimed in claim 11 wherein the method further comprises configuring the payment card with an identifier of a radio frequency identification tag on the person of an owner of the card; and wherein requesting a third code comprises attempting to read a code from the radio frequency identification tag.
